(19) United States
(12) Patent Application Publication
(10) Pub. No.: US 2024/0181707 A1
(43) Pub. Date: Jun. 6, 2024

(54) METHOD FOR OPTIMIZING DESIGN AND MANUFACTURE OF SELF-SUPPORTING STRUCTURE BASED ON MULTI-AXIS 3D PRINTING

(71) Applicants: HANGZHOU CITY UNIVERSITY, Hangzhou City (CN); ZHEJIANG UNIVERSITY, Zhejiang (CN)

(72) Inventors: Zhen WANG, Hangzhou City (CN); Jun YE, Hangzhou City (CN); Yang ZHAO, Hangzhou City (CN); Hongjia LU, Hangzhou City (CN); Qichen GUO, Hangzhou City (CN); Huiping TANG, Hangzhou City (CN); Guan QUAN, Hangzhou City (CN); Zhi DING, Hangzhou City (CN)

(73) Assignees: HANGZHOU CITY UNIVERSITY, Hangzhou City (CN); ZHEJIANG UNIVERSITY, Zhejiang Province (CN)

(21) Appl. No.: 18/242,281

(22) Filed: Sep. 5, 2023

(30) Foreign Application Priority Data
Oct. 25, 2022 (CN) 202211307783.9

(51) Int. Cl. B29C 64/386

(52) U.S. Cl. CPC B29C 64/386; B33Y 50/00

(57) ABSTRACT

A method for optimizing design and manufacture of a self-supporting structure based on multi-axis 3D printing are provided, which comprises the following steps: using a structural topology optimization method based on an SIMP model to achieve the optimal configuration design of a complex structure, converting an image into a binary image, and post-processing the result of topology optimization; determining an overhanging angle of a structure boundary, and determining the printing direction of different printing partitions according to the classification; performing integrated optimization of angle constraints; extracting structural information, establishing a 3D solid model, and then partitioning and slicing the model, and generating a printing path for self-supporting multi-axis 3D printing manufacturing. The present disclosure has the beneficial effects that the self-supporting structure is generated in the optimization process, no additional support is needed in the printing process.

### CROSS-REFERENCE TO RELATED APPLICATION

This patent application claims the benefit and priority of Chinese Patent Application No. 202211307783.9 filed with the China National Intellectual Property Administration on Oct. 25, 2022, the disclosure of which is incorporated by reference herein in its entirety as part of the present application.

### TECHNICAL FIELD

The present disclosure belongs to the technical field of structural engineering, and in particular relates to a method for optimizing design and manufacture of a self-supporting structure based on multi-axis 3D printing. Multi-axis means that the total number of rotating axes in 3D printing is greater than 3 axes, including the rotating axes of a printing head and the rotating axes of a base.

### BACKGROUND

With the increasing complexity of engineering structures and the increasing demand for 3D printing of complex structures, traditional structural design methods are often not competent, and topology optimization provides an effective solution for this purpose. Topologically optimized structures are excellent in mechanical properties and reasonable in material distribution, but the geometric structure is often complex, which is difficult to be popularized and applied due to traditional manufacturing processes.

Compared with the traditional manufacturing processes, 3D printing technology has the advantages of high efficiency and high precision, and is more suitable for the processing and manufacturing of complex structures. However, 3D printing still requires the structure to meet the corresponding manufacturing constraints to ensure the success of the printing process. Among many manufacturing constraints, the overhanging effect caused by gravity is one of the main manufacturing constraints of 3D printing. The overhanging effect means that when the included angle between the structure boundary and the horizontal plane is less than a critical value (for example, a critical angle of DMLS is 45 degrees), due to the existence of gravity, collapse will occur in the material deposition process, which will affect the printing quality of the structure and even lead to printing failure. This constraint greatly limits the ability of 3D printing to manufacture geometric components.

In order to overcome the overhanging effect, a support structure can be added to the overhanging part of the structure, and the support can be removed by physical or chemical means after printing is completed. However, the use of the support structure will lead to additional material consumption, and it is often difficult to remove the support needed for metal structure printing. Although the volume of the supporting structure can be minimized by adjusting the molding direction of the structure, it is still impossible to completely avoid the use of the supporting structure.

Another way to overcome the overhanging effect is to introduce angle constraints into structural optimization design from the perspective of the structural design to obtain the optimal mechanical performance structure that meets the angle manufacturing constraints, that is, the topological optimization design of a self-supporting structure for 3D printing. At present, the research on this method mainly focuses on 3-axis 3D printing. Although a self-supporting structure that meets the manufacturing constraints can be obtained to avoid the use of the support, it often leads to a significant increase in material consumption and a significant decline in structural performance.

With the rapid development of machinery industry, multi-axis 3D printing technology is widely used in aerospace, vehicle engineering and other fields. Compared with the 3-axis 3D printer, the multi-axis 3D printer has a freely rotating base, so as to dynamically adjust the printing direction in the printing process to avoid the overhanging effect of the structure in the printing process, and effectively solve the problems of volume increase and performance sharp decline in 3-axis 3D printing of the self-supporting structure. Therefore, the reasonable and effective combination of multi-axis 3D printing manufacturing and self-supporting structure optimization design is an important factor in the integrated optimization design and manufacturing of complex structures.

To sum up, it is necessary to study a method for optimizing design and manufacture of self-supporting structure based on multi-axis 3D printing, and realize the integrated design and manufacturing of multi-axis 3D printing with the optimal configuration of a complex self-supporting structure at any inclination angle.

### SUMMARY

The present disclosure aims to overcome the shortcomings in the prior art and provide a method for optimizing design and manufacture of self-supporting structure based on multi-axis 3D printing.

The method for optimizing design and manufacture of a self-supporting structure based on multi-axis 3D printing comprises the following steps:

S1, topology optimization without overhanging constraints: using a structural topology optimization method based on an SIMP model to realize the optimal configuration design of a complex structure, converting an image into a binary image, and post-processing a result of the topology optimization;

S2, multi-axis 3D partition printing optimization: first, extracting a structural boundary, determining an overhanging angle of the structure boundary, dividing the structure into printing partitions, classifying the printing partitions, determining the direction of different printing partitions printing according to classification; and performing integrated optimization of angle constraints;

S3, 3D printing integrated manufacturing: extracting structural information through optimization results, establishing a 3D solid model by a process of assembling components and generating nodes, partitioning and slicing the solid model, and generating a printing path for self-supporting multi-axis 3D printing manufacturing.

Preferably, step S1 specifically comprises:

S1.1, structural topology optimization design: using the SIMP model based on density as a topology optimization method, using four-node rectangular units to discretize a design domain, and under a given load and given boundary conditions, using the density ρₑ=ρ₁, ρ₂, . . . , ρₙₑₗₑ of each unit in the design domain as a design variable, wherein the equation of structural topology optimization is:

$$\\ \{ \begin{matrix}find : ρ = ( {ρ}_{1} , {ρ}_{2} , … , {ρ}_{nele} ) \\ min : C ( ρ ) = {F}^{T} U = {U}^{T} K ( ρ ) U \\ s . t . : K ( ρ ) U = F \\ V ( ρ ) = \frac{{\sum }_{i = 1}^{nele} {v}_{i} {ρ}_{i}}{{\sum }_{i = 1}^{nele} {v}_{i}} \leq f \\ 0 \leq {ρ}_{i} \leq 1 , ( i = 1 , 2 , … , nele )\end{matrix}$$

where U is a global displacement vector; F is a global node load vector; K is a total stiffness matrix; an objective function C(ρ) is a total strain energy under an external force; vᵢ is the volume of the i-th unit; f is the proportion of space; the unit density ρₑ has a value between 0 and 1;

the structure obtained by topology optimization is subjected to heaviside projection transformation, and then the threshold δ=0.5 is set for the unit with the unit density ρₑ between 0 and 1, and the equation of binarization processing of the unit density ρₑ is as follows:

$$\\ {ρ}_{e}^{{}^{} *} = \{ \begin{matrix}1 {\tilde{ρ}}_{e} \geq 0.5 \\ 0 {\tilde{ρ}}_{e} < 0.5\end{matrix}$$

S1.2, post-processing of topology optimization: post-processing isolated units and tiny holes in the obtained binary image by identifying a connected domain.

Preferably, step S2 specifically comprises:

S2.1, determining the overhanging angle of the structural boundary: inputting the binary image obtained in step S1 in a matrix form to obtain density values in a neighborhood of each unit; if the density in the neighborhood of a unit is 0, the unit is a boundary unit; fitting the unit density of the boundary unit without binarization processing in the neighborhood to obtain a gradient normal vector of the boundary unit, and taking the orthogonal direction of the gradient normal vector as the boundary overhanging direction; and using a least square method to fit the unit density in the neighborhood to obtain the gradient direction of the unit density;

S2.2, determining the direction of the partition printing: extracting graphic feature points, dividing a grid using the feature points to discretize the design domain, obtaining different printing partitions, classifying the printing partitions according to the classification of the units contained in the printing partitions, and determining the printing directions of different partitions , respectively;

S2.3, integrated optimization of angle constraints: performing angle constraints on the units in each partition according to local printing directions of the structure determined in step S2.2; and realizing supplementary optimization design and printing of an insufficiently printed area.

Preferably, in step S2.1, each unit supporting domain is divided by a six-unit mode or a nine-unit mode, each unit supporting domain is divided into a left supporting domain and a right supporting domain, normal vectors of a left boundary and a right boundary of the structure are obtained by fitting the unit density by the least square method, respectively, and the normal vectors of the left boundary and the right boundary are inner-producted with the structural molding direction, respectively, so as to obtain a magnitude of the left boundary and the right boundary of the structure violating a critical overhanging angle:

$$\\ \{ \begin{matrix}{t}_{il} = ( cos {α}_{l} - cos \overline{α} ) ‖ ∇ {\tilde{ρ}}_{l} ‖ \leq {ε}_{i 1} \\ {t}_{ir} = ( cos {α}_{r} - cos \overline{α} ) ‖ ∇ {\tilde{ρ}}_{r} ‖ \leq {ε}_{i 1}\end{matrix} , i = 1 , 2 , … , nele$$

where cosαₗ and cosαᵣ are cosine values of the normal vectors of the left boundary and the right boundary of the structure, respectively; cos ā is a cosine of the critical overhanging angle of the structure; ∇\tilde{ρ} ₗ and ∇\tilde{ρ} ᵣ are gradient normal vectors of the left boundary and the right boundary of the structure, respectively; tᵢₗ and tᵢᵣ are magnitudes of the left boundary and the right boundary violating the critical overhanging angle, respectively, tᵢₗ and tᵢᵣ are processed by a penalty function and converted into discrete values in the range of 0-1,

$$\\ h ( x ) = \frac{1}{1 + {e}^{- μ x}}$$

where μ represents the smoothness of a function curve, μ has a value between 65 and 95, a parameter value λᵢ characterizing the overhanging angle of the unit is obtained as follows:

λᵢ=h(tᵢₗ −εᵢₗ)·h(tᵢᵣ−εᵢᵣ)

when the unit violates the critical overhanging angle of the structure, the value of λᵢ is 1, otherwise the value is 0, that is:

$$\\ {λ}_{i} = \{ \begin{matrix}0 , {t}_{il} - {ε}_{i 1} \leq 0 or {t}_{ir} - {ε}_{i 1} \leq 0 \\ 1 , others\end{matrix}$$

Preferably, in step S2.1, a constraint term p(\tilde{ρ}) of the overhanging angle of the boundary unit and a constraint term q(\tilde{ρ}) of the unit density in the horizontal neighborhood of the unit are added to the equation of structural topology optimization, and the constraint item takes into account the parameter value γᵢ characterizing the overhanging feature of the structural boundary unit after topology optimization,

after taking into account the constraint item p(\tilde{ρ}) and the constraint item q(\tilde{ρ}), the optimization equation is:

$$\\ \{ \begin{matrix}find : ρ = ( {ρ}_{1} , {ρ}_{2} , … , {ρ}_{nele} ) \\ min : C ( ρ ) = {F}^{T} U = {U}^{T} K ( \tilde{ρ} ) U \\ s . t . : K ( \tilde{ρ} ) U = F \\ V ( \tilde{ρ} ) = \frac{{\sum }_{i = 1}^{nele} {v}_{i} {\tilde{ρ}}_{e}}{{\sum }_{i = 1}^{nele} {v}_{i}} \leq f \\ 0 \leq {ρ}_{i} \leq 1 , ( i = 1 , 2 , … , nele ) \\ q ( \tilde{ρ} ) = \frac{{\sum }_{i = 1}^{nele} {γ}_{i} {v}_{i} {\tilde{ρ}}_{e}}{{\sum }_{i = 1}^{nele} {v}_{i}} \leq 0 \\ p ( \tilde{ρ} ) = \frac{{\sum }_{i = 1}^{nele} {λ}_{i} {v}_{i} {\tilde{ρ}}_{e}}{{\sum }_{i = 1}^{nele} {v}_{i}} \leq 0\end{matrix}$$

where U is a global displacement vector; F is a global node load vector; K is a total stiffness matrix; an objective function C(ρ) is a total strain energy under an external force; v i is a volume of the i-th unit; f is a proportion of space; q(\tilde{ρ}) is a constraint item of the unit density in the horizontal neighborhood of the unit, and p(\tilde{ρ}) is a constraint item of the overhanging angle of the boundary unit, where ρ=(ρ₁, ρ₂, . . . ρₙₑₗₑ) is the density of each unit,

γᵢ is the parameter value taking into account the overhanging feature of the boundary unit of the structure after topology optimization, γᵢ is obtained by referring to the solution process of λᵢ, and the magnitude of the left boundary and the right boundary of the structure violating the overhanging feature is:

$$\\ \{ \begin{matrix}{t}_{il} = \tilde{ρ} {}_{1}^{{}^{} l} - \frac{\tilde{ρ} {}_{2}^{{}^{} l} + \tilde{ρ} {}_{4}^{{}^{} l} + \tilde{ρ} {}_{6}^{{}^{} l} + {}^{} … + \tilde{ρ} {}_{2 m}^{{}^{} l}}{m} \leq {ε}_{i 2} \\ {t}_{ir} = \tilde{ρ} {}_{1}^{{}^{} l} - \frac{\tilde{ρ} {}_{3}^{{}^{} l} + \tilde{ρ} {}_{5}^{{}^{} l} + \tilde{ρ} {}_{7}^{{}^{} l} + {}^{} … + \tilde{ρ} {}_{2 m + 1}^{{}^{} l}}{m} \leq {ε}_{i 2}\end{matrix} , i = 1 , 2 , … , nele$$

where \tilde{ρ}₂^{l}, \tilde{ρ}₄^{l}, \tilde{ρ}₆^{l}, . . . , \tilde{ρ}₂ₘ^{l} and \tilde{ρ}₃^{l}, \tilde{ρ}₄^{l}, \tilde{ρ}₇^{l}, . . . , \tilde{ρ}₂ₘ₊₁^{l}, are the unit densities of the left boundary and the right boundary, respectively, and t u and t ir are the magnitudes of the left boundary and the right boundary violating the critical overhanging angle, respectively,

the parameter value λᵢ characterizing the overhanging feature of the boundary unit is

λᵢ=h(τᵢₗ−εᵢ₂)·h(τᵢᵣ−εᵢ₂)

when the unit violates the overhanging feature of the structure, the value of λᵢ is 1, otherwise the value is 0; that is:

$$\\ {γ}_{i} = \{ \begin{matrix}0 , {τ}_{il} - {ε}_{i 2} \leq 0 or {τ}_{ir} - {ε}_{i 2} \leq 0 \\ 1 , others\end{matrix}$$

Preferably, in step S2.2, the printing partitions are classified into three categories, the printing partitions comprise Class I areas, Class II area and Class III area; Class I area only contains structure units, Class II area contains boundary units, and Class III area contains neither boundary units nor structure units; when judging the classification of the printing partitions in the part in the structure with vertical support, all units in the part with vertical support are not regarded as boundary units;

the local printing direction of Class I area is adjusted arbitrarily within the range of the overhanging angle; the local printing direction of Class II area is determined by the inclined direction of the boundary units; and the local printing direction of Class III area is set arbitrarily.

Preferably, in step S2.2, an angle difference of the printing direction in the horizontally adjacent areas is greater than a maximum deflection angle; and a local optimal printing direction of the area is determined by the following equation:

$$\\ \{ \begin{matrix}find : φ = ( {φ}_{1} , {φ}_{2} , … , {φ}_{n} ) \\ min : {o}^{T} V \\ s . t . : o \geq \vert M φ - \overline{φ} - {φ}_{max} \vert + \vert M φ - \overline{φ} + {φ}_{max} \vert \\ {φ}_{next} - {φ}_{first} > {φ}_{t , max}\end{matrix}$$

whereφ=(φ₁, φ₂, . . . , φₙ) is the local printing direction of each printing partition, o represents that the inclination angle of the unit violates the critical overhanging constraints; φ̅ is the inclination angle of the unit; φₘₐₓ is the maximum overhanging angle; φₙₑₓₜ and φ_{first} are the angles of the local printing direction of two adjacent printing partitions, respectively, and φ_{t,max} is the maximum deflection angle.

Preferably, in step S2.3, the optimal local printing direction of each partition is determined by the inclined direction of the boundary units in each partition, and the local printing direction of the structure is used in the constraint item p(\tilde{ρ}) to characterize the parameter value λᵢ (φᵢ) of the overhanging angle of the unit, and the equation taking into account the linear angle constraint of the unit in each printing partition is:

$$\\ \{ \begin{matrix}find : ρ = ( {ρ}_{1} , {ρ}_{2} , … , {ρ}_{nele} ) \\ min : C ( ρ ) = {F}^{T} U = {U}^{T} K ( \tilde{ρ} ) U \\ s . t . : K ( \tilde{ρ} ) U = F \\ V ( \tilde{ρ} ) = \frac{{\sum }_{i = 1}^{nele} {v}_{i} {\tilde{ρ}}_{e}}{{\sum }_{i = 1}^{nele} {v}_{i}} \leq f \\ 0 \leq {ρ}_{i} \leq 1 , ( i = 1 , 2 , … , nele ) \\ q ( \tilde{ρ} ) = \frac{{\sum }_{i = 1}^{nele} {γ}_{i} {v}_{i} {\tilde{ρ}}_{e}}{{\sum }_{i = 1}^{nele} {v}_{i}} \leq 0 \\ p ( \tilde{ρ} ) = \frac{{\sum }_{i = 1}^{nele} {λ}_{i} ( {φ}_{i} ) {v}_{i} {\tilde{ρ}}_{e}}{{\sum }_{i = 1}^{nele} {v}_{i}} \leq 0\end{matrix}$$

where U is a global displacement vector; F is a global node load vector; K is a total stiffness matrix; an objective function C(ρ) is a total strain energy under an external force; v i is a volume of the i-th unit; f is a proportion of space; q(p(\tilde{ρ}) is a constraint item of the unit density in the horizontal neighborhood of the unit, and p(\tilde{ρ}) is a constraint item of the linear angle of the optimal local printing direction of the unit in each partition, where ρ=(ρ₁, ρ₂, . . . , ρₙₑₗₑ) is the density of each unit; and λᵢ(φᵢ) is a parameter characterizing the optimal local printing direction of the unit.

Preferably, in step S3, 3D modeling is performed by Rhino software; a solid model obtained by 3D modeling is sliced by Cura software, and the printing path is generated.

The present disclosure has the following beneficial effects.

1) According to the method for optimizing design and manufacture of the self-supporting structure based on multi-axis 3D printing provided by the present disclosure, the self-supporting structure is generated in the optimization process, and no additional support is needed in the printing process, so that the material cost and the printing time are saved, and the integrated design and manufacturing of multi-axis 3D printing without supporting structure are realized.

2) The method for optimizing design and manufacture of the self-supporting structure based on multi-axis 3D printing provided by the present disclosure is based on the combination of topology optimization without overhanging constraints and multi-axis 3D partition printing optimization, realizes the optimal configuration of the structure without overhanging constraints through density-based SIMP model topology optimization. The optimal configuration printing of the complex self-supporting structure at any inclination angle is realized by multi-axis partitioning 3D printing taking into account rotating axes of a printing head and of a base. The supplementary optimization design and printing of the insufficiently printed area are realized by integrated optimization of angle constraints. The integrated design and manufacturing of multi-axis 3D printing with optimal configuration of the complex self-supporting structure are realized by 3D modeling, partitioning and slicing a solid model, and generating a printing path.

3) Based on the multi-axis partitioning 3D printing taking into account the rotating axes of the printing head and the base, the present disclosure realizes the optimal configuration printing of the complex self-supporting structure at any inclination angle by dynamically adjusting the printing direction in the printing process to avoid the overhanging effect of the structure in the printing process. The supplementary optimal design and printing of the insufficient printing area are realized through the integrated optimization of the angle constraint, thus effectively solving the problems of volume increase and performance sharp decline in 3D printing of the self-supporting structure.

### BRIEF DESCRIPTION OF THE DRAWINGS

FIG. 1 is a concrete flowchart of a method for optimizing design and manufacture of self-supporting structure based on multi-axis 3D printing according to the present disclosure.

FIG. 2 is a schematic diagram of density distribution phenomenon of a checkerboard pattern in topology optimization.

FIG. 3 is a schematic diagram of a circular neighborhood of a unit.

FIG. 4A is a schematic diagram of tiny defects of the structure after topology optimization, and FIG. 4B is a schematic diagram of a binary image of the structure after being repaired and processed.

FIG. 5 is a schematic diagram of a unit neighborhood pattern.

FIG. 6A is a schematic diagram of the structure after topology optimization, and FIG. 6B is a schematic diagram of a structural boundary unit extracted after the discrimination operation of the structural boundary unit.

FIG. 7A is a schematic diagram of a unit supporting domain of a “six-unit mode”, and FIG. 7B is a schematic diagram of a unit supporting domain of a “nine-unit mode”.

FIG. 8A is a schematic diagram of a left supporting domain of a “six-unit mode”, and FIG. 8B is a schematic diagram of a right supporting domain of a “six-unit mode”.

FIG. 9 is a schematic diagram showing the overhanging feature of the structure after topology optimization.

FIG. 10A is a schematic diagram of an original structure after topology optimization, and FIG. 10B is a schematic diagram of the part that can be printed along the numerical direction.

FIG. 11 is a schematic diagram of a partition obtained after extracting graphic features.

FIG. 12 is a schematic diagram of collision phenomenon in the printing process.

FIG. 13A is a schematic diagram of a design domain of an MBB beam, FIG. 13B is a schematic diagram of an optimal topological configuration result of an MBB beam, FIG. 13C is a schematic diagram of a printing partition of an MBB beam, and FIG. 13D is a schematic diagram of a printing curve of an MBB beam.

FIG. 14A is a schematic diagram of a design domain of a cantilever beam, FIG. 14B is a schematic diagram of an optimal topological configuration result of a cantilever beam, FIG. 14C is a schematic diagram of a printing partition of a cantilever beam, and FIG. 14D is a schematic diagram of a printing curve of a cantilever beam.

### DETAILED DESCRIPTION OF THE EMBODIMENTS

The present disclosure will be further described in conjunction with embodiments. The description of the following embodiments is only for the purpose of helping to understand the present disclosure. It should be pointed out that, for those skilled in the art, several modifications can be made to the present disclosure without departing from the principle of the present disclosure, and these improvements and modifications also fall within the scope of protection of the claims of the present disclosure.

### Embodiment 1

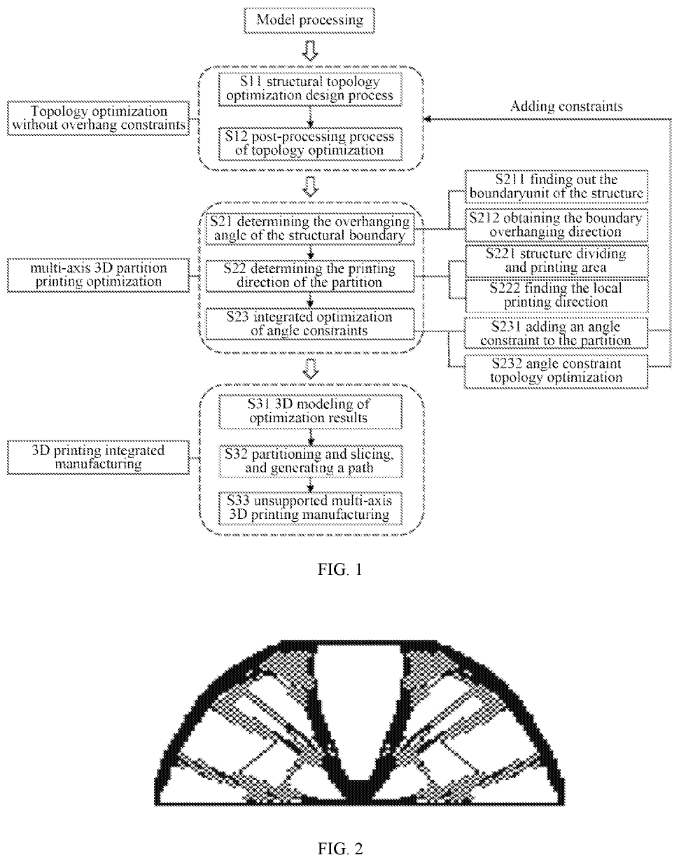

As an embodiment, as shown in FIG. 1, a method for optimizing design and manufacture of self-supporting structure based on multi-axis 3D printing comprises the following steps.

S 1, topology optimization without overhanging constraints: using a method structural topology optimization method based on an SI1VIP model is used to realize the optimal configuration design of a complex structure, an image is converted into a binary image, and the result of topology optimization is post-processed. Specifically,

51.1, structural topology optimization design: using the SIMP model based on density as a topology optimization method, using four-node rectangular units to discretize a design domain, and under a given load and given boundary conditions, using the density ρₑ=ρ₁, ρ₂, . . . , ρₙₑₗₑ of each unit in the design domain as a design variable, wherein the equation of structural topology optimization is:

$$\\ \{ \begin{matrix}find : ρ = ( {ρ}_{1} , {ρ}_{2} , … , {ρ}_{nele} ) \\ min : C ( ρ ) = {F}^{T} U = {U}^{T} K ( ρ ) U \\ s . t . : K ( ρ ) U = F \\ V ( ρ ) = \frac{{\sum }_{i = 1}^{nele} {v}_{i} {ρ}_{i}}{{\sum }_{i = 1}^{nele} {v}_{i}} \leq f \\ 0 \leq {ρ}_{i} \leq 1 , ( i = 1 , 2 , … , nele )\end{matrix}$$

where U is a global displacement vector; F is a global node load vector; K is a total stiffness matrix; an objective function C(ρ) is a total strain energy under an external force; v, is the volume of the i-th unit; f is the proportion of space; the unit density ρₑ has a value between 0 and 1.

In order to make the unit density approach the discrete value of 0 or 1, the SIMP model introduces the density penalty term to the elastic modulus of materials:

E(ρₑ)=Eₘᵢₙ+ρₑ^{p}(E₀−Eₘᵢₙ)

where E (p e) is the elastic modulus of the material after nonlinear interpolation; Eₘᵢₙ is the minimum elastic modulus of materials to avoid singularity of a stiffness matrix; E₀ is the Young's modulus of the material; p is the density penalty parameter; if the value of p is too small, it will be difficult to obtain the design variable value close to the discrete value; if the value of p is too large, the nonlinear degree of the optimization problem will be improved, and it is difficult to obtain ideal convergence results. In this embodiment, the commonly used value of p in practical engineering is taken as 3.

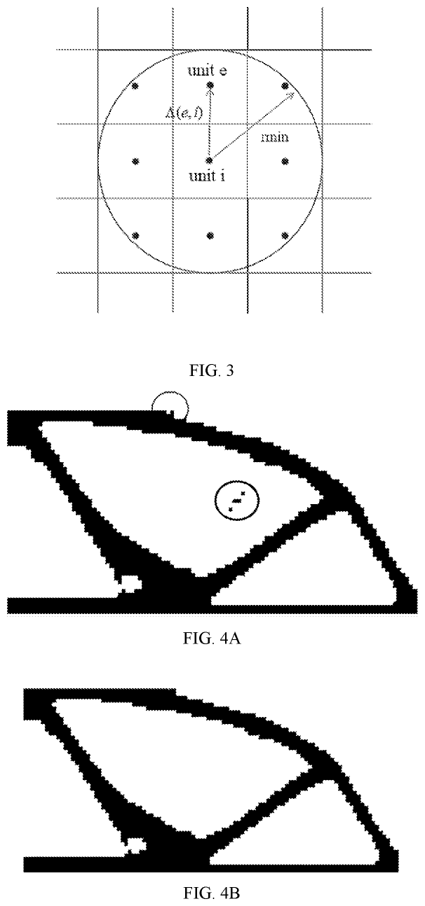

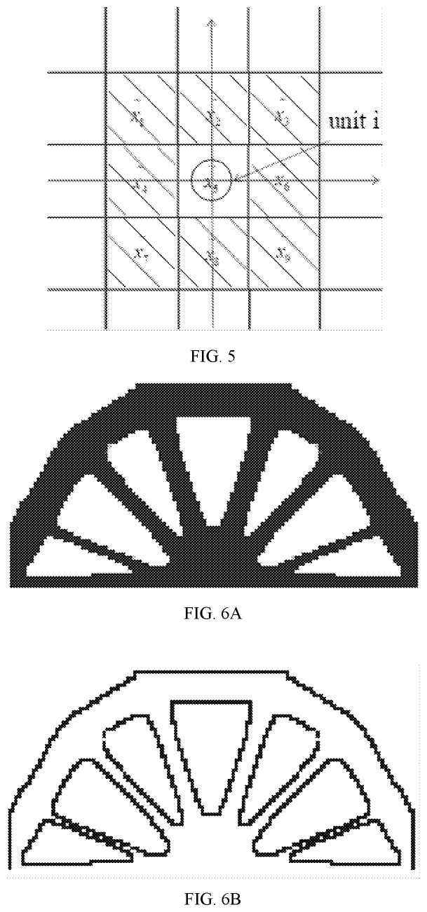

As shown in FIG. 2 and FIG. 3, the density distribution phenomenon of the checkerboard pattern often occurs in the optimization process, which will cause the grid dependence of optimization. That is, the optimization result is related to the mode of dividing grids. Therefore, density filtering is needed in the optimization process, and the equation is:

$$\\ \overline{{ρ}_{e}} = \frac{{\sum }_{i ∈ {N}_{e}} {ρ}_{i} {H}_{ei}}{{\sum }_{i ∈ {N}_{e}} {H}_{ei}}$$

where Nₑ is the neighborhood of the e-th unit, in which the center of mass of the e-th unit is taken as the center, and the calculation equation of Hₑᵢ is:

Hₑᵢ=rₘᵢₙ−Δ(e, i)

where rₘᵢₙ is a circular area with a radius, and Δ(e, i) is the distance between the centroid of the e-th unit and the centroid of the i-th unit, as shown in FIG. 3, which is a schematic diagram of the neighborhood of the unit.

The unit density obtained by density filtering is further converted into discrete values of 0 and 1 through the heaviside projection transformation, and the functional equation of the heaviside projection transformation is as follows:

$$\\ {\tilde{ρ}}_{e} = \{ \begin{matrix}η [ {e}^{- β ( 1 - {\overline{ρ}}_{e} / η )} - ( 1 - {\overline{ρ}}_{e} / η ) {e}^{- β} ] & 0 \leq {\overline{ρ}}_{e} \leq η \\ ( 1 - η ) [ 1 - {e}^{- β ( {\overline{ρ}}_{e} - η ) / ( 1 - η )} + ( {\overline{ρ}}_{e} - η ) {e}^{- β} / ( 1 - η ) ] + η {}^{} & η \leq {\overline{ρ}}_{e} \leq 1\end{matrix}$$

where the parameter η is the threshold parameter of the heaviside function, and the value of η should ensure that the proportion of space of the structure after the unit density is transformed by the heaviside function is the same as that of the original structure, which is generally determined by dichotomy; the parameter β characterizes the smoothness of the curve, and if the value is too large, an unhealthy matrix occurs in the optimization process.

For the unit whose unit density ρₑ is still between 0 and 1 after the heaviside projection transformation, the threshold δ=0.5 is set, and the following processing is carried out on the unit density ρ₃:

$$\\ {ρ}_{e}^{{}^{} *} = \{ \begin{matrix}1 {\tilde{ρ}}_{e} \geq 0.5 \\ 0 {\tilde{ρ}}_{e} < 0.5\end{matrix}$$

S1.2, post-processing of topology optimization: as shown in FIG. 4A, because the mechanical constraints of the structure are not taken into account in the above equation, there are occasional small defects in the local structure, which is unfavorable for determining the gradient direction of the boundary of the structure. The small defects of the structure needs to be pre-processed. Post-processing isolated units and tiny holes in the obtained binary image by identifying a connected domain, and the image as shown in FIG. 4B is obtained.

S2, multi-axis 3D partition printing optimization: first, a structural boundary is extracted, an overhanging angle of the structure boundary is determined, the structure is divided into printing partitions, the printing partitions are classified, the direction of different partitions printing is determined according to the classification, and integrated optimization of angle constraints is performed. Specifically,

S2.1, determining the overhanging angle of the structural boundary: as shown in FIGS. 6A and 6B, the binary image obtained in step S1 in a matrix form is input to obtain the density values in the neighborhood of each unit; if the density in the neighborhood of a unit is 0, the unit is a boundary unit; the unit density of the boundary unit without binarization processing in the neighborhood is fit to obtain a gradient normal vector of the boundary unit, and the orthogonal direction of the gradient normal vector is taken as the boundary overhanging direction. This method can fit the smooth boundary of the structure with satisfactory results, but the fitting effect of the units with sharp boundary is often not ideal. However, because such units often account for less than 1% of the total number of boundary units, the overall impact is small.

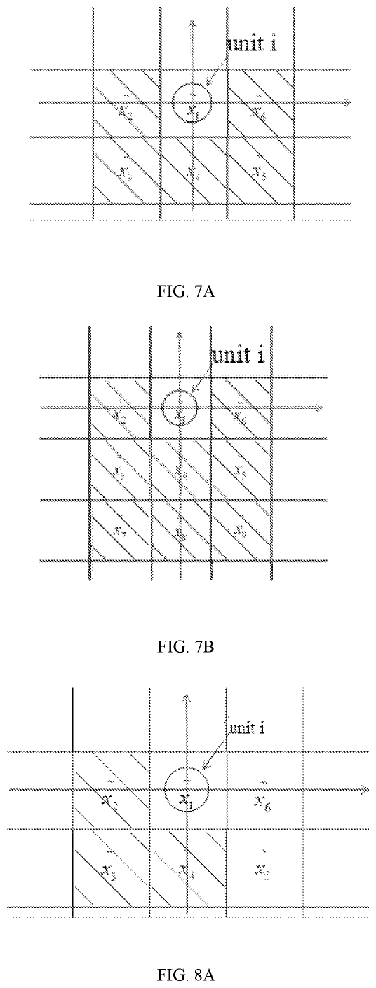

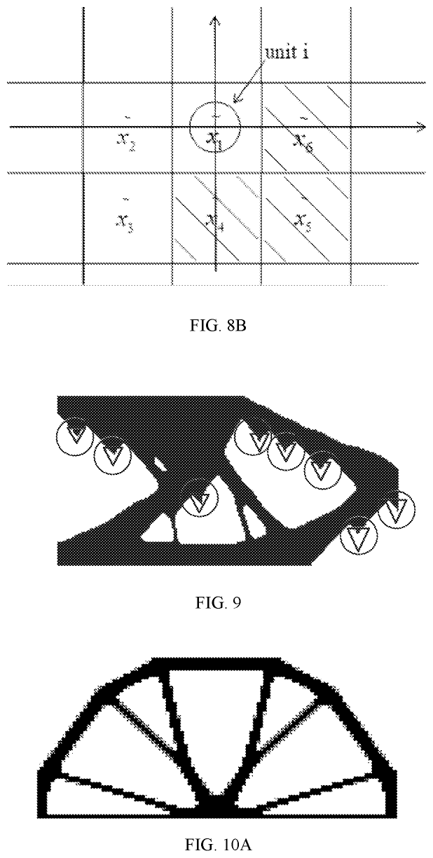

Each unit supporting domain is divided by a six-unit mode or a nine-unit mode, each unit supporting domain is divided into a left supporting domain and a right supporting domain, and the unit supporting domain and the left supporting domain and the right supporting domain of the six-unit mode and the nine-unit mode is shown in FIGS. 7A-8B. Normal vectors of a left boundary and a right boundary of the structure are obtained by fitting the unit density by the least square method, respectively, and the normal vectors of the left boundary and the right boundary are inner-producted with the structural molding direction, respectively, so as to obtain the magnitude of the left boundary and the right boundary of the structure violating a critical overhanging angle:

$$\\ \{ \begin{matrix}{t}_{il} = ( cos {α}_{l} - cos \overline{α} ) ‖ ∇ {\tilde{ρ}}_{l} ‖ \leq {ε}_{i 1} \\ {t}_{ir} = ( cos {α}_{r} - cos \overline{α} ) ‖ ∇ {\tilde{ρ}}_{r} ‖ \leq {ε}_{i 1}\end{matrix} , i = 1 , 2 , … , nele$$

where cosαₗ and cosαᵣ are the cosine values of the normal vectors of the left

boundary and the right boundary of the structure, respectively; cos α̅ is the cosine of the critical overhanging angle of the structure; ∇\tilde{ρ} ₗ and ∇\tilde{ρ} ᵣ are the gradient normal vectors of the left boundary and the right boundary of the structure, respectively; tᵢₗ and tᵢᵣ are the magnitudes of the left boundary and the right boundary violating the critical overhanging angle, respectively, tᵢₗ and tᵢᵣ are processed by a penalty function and converted into discrete values in the range of 0-1,

$$h ( x ) = \frac{1}{1 + {e}^{- μ x}}$$

where h(x) is a Sigmoid function, μ represents the smoothness of a function curve, pt has a value between 65 and 95, the parameter value λᵢ characterizing the overhanging angle of the unit is obtained as follows:

λᵢ=h(tᵢₗ−εᵢ₁)·h(tᵢᵣ−εᵢᵣ)

When the unit violates the critical overhanging angle of the structure, the value of λᵢ is 1, otherwise the value is 0, that is:

$${λ}_{i} = \{ \begin{matrix}0 , {t}_{i l} - {ε}_{i 1} \leq 0 or {t}_{ir} - {ε}_{i 1} \leq 0 \\ 1 , others\end{matrix}$$

Therefore, a constraint item p(\tilde{ρ}) of the overhanging angle of the boundary unit is added to the equation of structural topology optimization.

In order to avoid the overhanging feature as shown in FIG. 9 in the optimization process, a constraint item q(\tilde{ρ}) of the unit density in the horizontal neighborhood of the unit is added, which takes into account the parameter value λᵢ characterizing the overhanging feature of the structural boundary unit after topology optimization.

After taking into account the constraint item p(\tilde{ρ}) and the constraint item q(\tilde{ρ}), the optimization equation is:

$$\{ \begin{matrix}find : ρ = ( {ρ}_{1} , {ρ}_{2} , … , {ρ}_{n e l e} ) \\ min : C ( ρ ) = {F}^{T} U = {U}^{T} K ( \tilde{ρ} ) U \\ s . t . : K ( \tilde{ρ} ) U = F \\ V ( \tilde{ρ} ) = \frac{{Σ}_{i = 1}^{n e l e} {v}_{i} {\tilde{ρ}}_{e}}{{Σ}_{i = 1}^{n e l e} {v}_{i}} \leq f \\ 0 \leq {ρ}_{i} \leq 1 , ( i = 1 , 2 , … , nele ) \\ q ( \tilde{ρ} ) = \frac{{Σ}_{i = 1}^{n e l e} {γ}_{i} {v}_{i} {\tilde{ρ}}_{e}}{{Σ}_{i = 1}^{n e l e} {v}_{i}} \leq 0 \\ p ( \tilde{ρ} ) = \frac{{Σ}_{i = 1}^{n e l e} {λ}_{i} {v}_{i} {\tilde{ρ}}_{e}}{{Σ}_{i = 1}^{n e l e} {v}_{i}} \leq 0\end{matrix}$$

where U is a global displacement vector; F is a global node load vector; K is a total stiffness matrix; an objective function C(ρ) is a total strain energy under an external force; v i is the volume of the i-th unit; f is the proportion of space; q(\tilde{ρ}) is a constraint item of the unit density in the horizontal neighborhood of the unit, and p(\tilde{ρ}) is a constraint item of the overhanging angle of the boundary unit, where ρ=(ρ₁, ρ₂, . . . , ρₙₑₗₑ) is the density of each unit.

The solution of γᵢ is obtained by referring to the solution process of λᵢ, and the magnitude of the left boundary and the right boundary of the structure violating the overhanging feature is:

$$\{ \begin{matrix}{τ}_{il} = {\tilde{ρ}}_{1}^{l} - \frac{{\tilde{ρ}}_{2}^{l} + {\tilde{ρ}}_{4}^{l} + {\tilde{ρ}}_{6}^{l} + … + {\tilde{ρ}}_{2 m}^{l}}{m} \leq {ε}_{i 2} \\ {τ}_{ir} = {\tilde{ρ}}_{1}^{l} - \frac{{\tilde{ρ}}_{3}^{l} + {\tilde{ρ}}_{5}^{l} + {\tilde{ρ}}_{6}^{l} + … + {\tilde{ρ}}_{2 m + 1}^{l}}{m} \leq {ε}_{i 2}\end{matrix} , i = 1 , 2 , … , nele$$

where where \tilde{ρ}₂^{l}, \tilde{ρ}₄^{l}, \tilde{ρ}₆^{l}, . . . , \tilde{ρ}₂ₘ^{l} and \tilde{ρ}₃^{l}, \tilde{ρ}₄^{l}, \tilde{ρ}₇^{l}, . . . , \tilde{ρ}₂ₘ₊₁^{l} are the unit densities of the left boundary and the right boundary, respectively, and tᵢₗ and tᵢᵣ are the magnitudes of the left boundary and the right boundary violating the critical overhanging angle, respectively.

The parameter value γᵢ characterizing the overhanging feature of the boundary unit is

γᵢ=h(τᵢₗ−εᵢ₂)·h(τᵢᵣ−εᵢ₂)

when the unit violates the overhanging feature of the structure, the value of γᵢ is 1, otherwise the value is 0; that is:

$${γ}_{i} = \{ \begin{matrix}0 , {τ}_{il} - {ε}_{i 2} \leq 0 or {τ}_{ir} - {ε}_{i 2} \leq 0 \\ 1 , others\end{matrix}$$

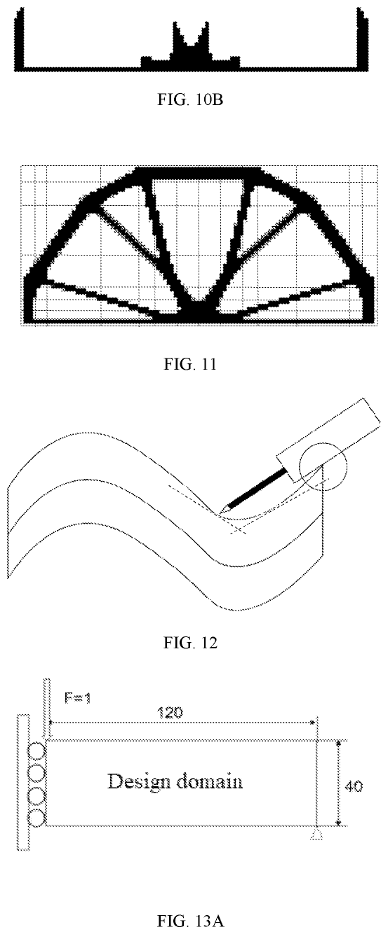

S2.2, determining the direction of the partition printing: graphic feature points are extracted, a grid is divided using the feature points to discretize the design domain, and different printing partitions are obtained. The printing partitions are classified into three categories, the printing partitions comprise Class I areas, Class II area and Class III area; Class I area only contains structure units, Class II area contains boundary units, and Class III area contains neither boundary units nor structure units; when judging the classification of the printing partitions in the part in the structure with vertical support, the part with vertical support in the structure should be excluded, as shown in the comparison between FIG. 10A and FIG. 10B. All units in the part with vertical support are not regarded as boundary units. The division of printing partitions can be determined manually or by extracting graphic feature points. The division of printing partitions obtained by extracting graphic feature points is shown in FIG. 11.

Because there is no boundary unit in Class I area, the local printing direction can be adjusted arbitrarily within the range of the overhanging angle. Because there is a boundary unit, the local printing direction of Class II area is determined by the inclined direction of boundary units. The local printing direction of Class III area has no influence on whether the structure can be printed successfully, and can be set arbitrarily.

As shown in FIG. 12, in order to ensure that the printing head does not collide with the structure in the printing process, it is necessary to ensure that the angle difference of the printing direction in the horizontally adjacent areas is greater than the maximum deflection angle; and the local optimal direction of the partition printing is determined by the following equation:

$$\{ \begin{matrix}find : φ = ( {φ}_{1} , {φ}_{2} , … , {φ}_{n} ) \\ min : {o}^{T} V \\ s . t . : o \geq \vert M φ - \overline{φ} - {φ}_{max} \vert + \vert M φ - \overline{φ} + {φ}_{max} \vert \\ {φ}_{n e x t} - {φ}_{f i τ s t} > {φ}_{t , max}\end{matrix}$$

where φ=(φ₁, φ₂, . . . , φₙ) is the local printing direction of each printing partition, o represents that the inclination angle of the unit violates the critical overhanging constraints; φ̅ is the inclination angle of the unit; φₘₐₓ is the maximum overhanging angle; φnext and φ_{firdt} are the angles of the local printing direction of two adjacent printing partitions, respectively, and φ_{t,max} is the maximum deflection angle.

S2.3, integrated optimization of angle constraints: the partition of the process is determined by the partition printing direction, and the local printing direction is determined. In some special cases, the structure cannot be fully printed, so that the local printing direction φᵢ of the structure determined in step S2.2 is added to the linear angle constraint item p(\tilde{ρ}) of the units in each partition as an angle constraint. Because the inclined direction of the boundary units in each partition determines the optimal local direction of each partition printing, the local printing direction of the structure can be used in the constraint item p(\tilde{ρ}) to characterize the parameter value λᵢ(φᵢ) of the overhanging angle of the unit, so as to realize the supplementary optimal design and printing of the insufficient area. The equation taking into account the linear angle constraint of the unit in each printing partition is:

$$\{ \begin{matrix}find : ρ = ( {ρ}_{1} , {ρ}_{2} , … , {ρ}_{n e l e} ) \\ min : C ( ρ ) = {F}^{T} U = {U}^{T} K ( \tilde{ρ} ) U \\ s . t . : K ( \tilde{ρ} ) U = F \\ V ( \tilde{ρ} ) = \frac{{Σ}_{i = 1}^{n e l e} {v}_{i} {\tilde{ρ}}_{e}}{{Σ}_{i = 1}^{n e l e} {v}_{i}} \leq f \\ 0 \leq {ρ}_{i} \leq 1 , ( i = 1 , 2 , … , nele ) \\ q ( \tilde{ρ} ) = \frac{{Σ}_{i = 1}^{n e l e} {γ}_{i} {v}_{i} {\tilde{ρ}}_{e}}{{Σ}_{i = 1}^{n e l e} {v}_{i}} \leq 0 \\ p ( \tilde{ρ} ) = \frac{{Σ}_{i = 1}^{n e l e} {λ}_{i} ( {φ}_{i} ) {v}_{i} {\tilde{ρ}}_{e}}{{Σ}_{i = 1}^{n e l e} {v}_{i}} \leq 0\end{matrix}$$

where U is a global displacement vector; F is a global node load vector; K is a total stiffness matrix; an objective function C(ρ) is a total strain energy under an external force; v, is the volume of the i-th unit; f is the proportion of space; q(\tilde{ρ}) is a constraint item of the unit density in the horizontal neighborhood of the unit, and p(\tilde{ρ}) is a constraint item of the linear angle of the optimal local printing direction of the unit in each partition, where ρ=(ρ₁, ρ₂, . . . , ρₙₑₗₑ) is the density of each unit; and λᵢ(φᵢ) is a parameter characterizing the optimal local printing direction (the boundary of the overhanging angle) of the unit, which is obtained from step S2.1 and step S2.2.

S3, 3D printing integrated manufacturing: structural information is extracted through optimization results, a 3D solid model is established through Rhino software by a process of assembling components and generating nodes, the solid model is partitioned and sliced through Cura software, and a printing path is generated for self-supporting multi-axis 3D printing manufacturing.

### Embodiment 2

According to the method for optimizing design and manufacture of the self-supporting structure based on multi-axis 3D printing proposed in Embodiment 1, this embodiment proposes a test embodiment for optimizing design and manufacture of a self-supporting structure based on multi-axis 3D printing of an MBB beam model to verify the effectiveness of the optimizing design and manufacture method of the present disclosure.

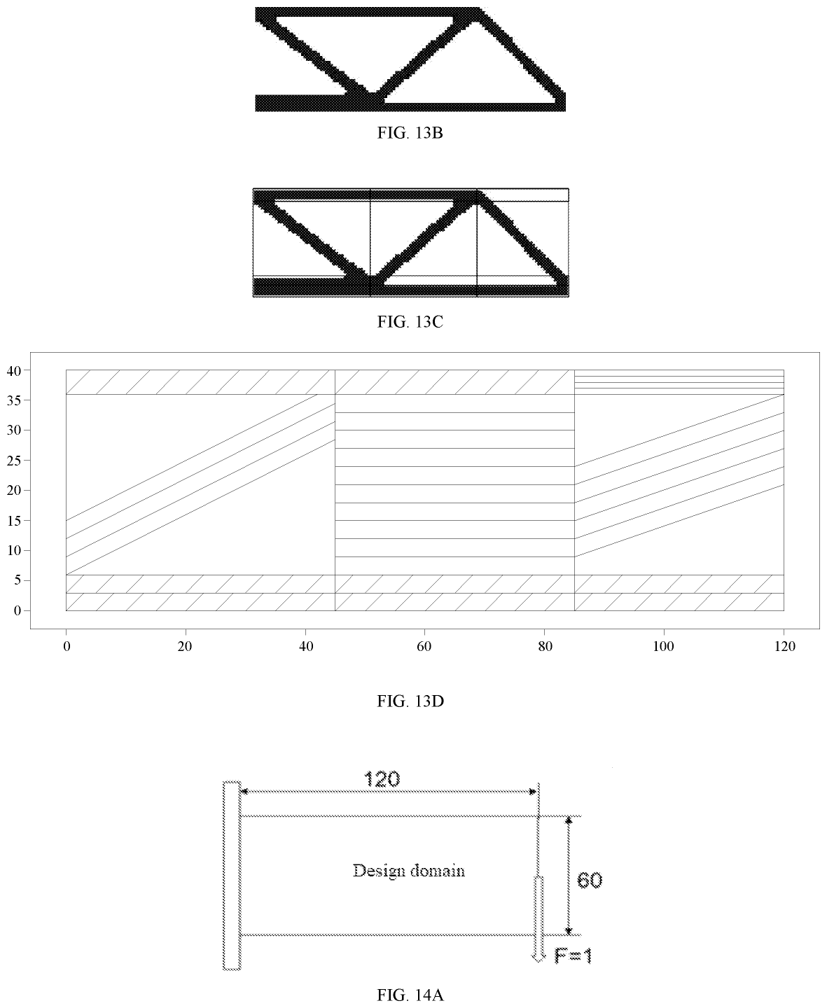

As shown in FIG. 13A, the MBB beam model has a length of 120, a height of 40, a Young's modulus of material of 1.0, a volume ratio constraint of 0.3, and a penalty coefficient of 3. The load, boundary conditions and the optimal topological configuration of the structure obtained after topology optimization are shown in FIG. 13B. The final objective function value after optimization is 339.4. The printing partition of the MBB beam and the printing curve of the MBB beam are shown in FIG. 13C and FIG. 13D, respectively.

In this embodiment, after taking into account multi-axis topology optimization, all units of the structure can be completely typed out, and there is no need for integrated optimization with angle constraints.

### Embodiment 3

According to the method for optimizing design and manufacture of the self-supporting structure based on multi-axis 3D printing proposed in Embodiment 1, this embodiment proposes a test embodiment for optimizing design and manufacture of a self-supporting structure based on multi-axis 3D printing of an MBB beam model to verify the effectiveness for optimizing design and manufacture method of the present disclosure.

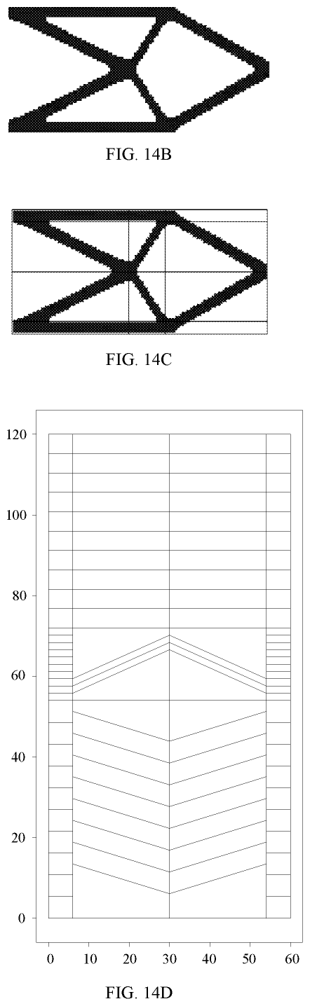

As shown in FIG. 14A, the cantilever beam model has a beam length of 120 and a height of 60, and has the same Young's modulus, volume ratio and penalty coefficient as those of the MBB beam model in Embodiment 1. The left end is a fixed end, and a load is applied at the midpoint of the right boundary of the beam. The optimal topology configuration after topology optimization is obtained as shown in FIG. 14B. The final objective function value after optimization is 121.03. The cantilever beam printing partition and the cantilever beam printing curve are shown in FIG. 14C and FIG. 14D, respectively.

In this embodiment, after taking into account the multi-axis topology optimization, all units of the structure can also be completely typed out, and there is no need for integrated optimization with angle constraints.

As can be seen from Embodiments 2 and 3, the method for optimizing design and manufacture of the self-supporting structure based on multi-axis 3D printing proposed by the present disclosure solves the problems that when designing complex structures and 3D printing, the overhanging effect caused by gravity leads to the disadvantages of having to add supports in the printing process, as well as additional material consumption and the need to remove supports, so as to realize the integrated design and manufacturing of multi-axis 3D printing of the optimal configuration of the complex self-supporting structures. In the printing process, the printing direction is dynamically adjusted to avoid the overhanging effect of the structure in the printing process. The supplementary optimal design and printing of the insufficient printing area are realized through the integrated optimization of the angle constraint, thus effectively solving the problems of volume increase and performance sharp decline in 3-axis 3D printing of the self-supporting structure.

What is claimed is:

1. A method for optimizing design and manufacture of a self-supporting structure based on multi-axis 3D printing, which comprises the following steps:
S1, topology optimization without overhanging constraints: using a structural topology optimization method based on an SIMP model to realize the optimal configuration design of a complex structure, converting an image into a binary image, and post-processing a result of the topology optimization;
S2, multi-axis 3D partition printing optimization: first, extracting a structural boundary, determining an overhanging angle of the structure boundary, dividing the structure into printing partitions, classifying the printing partitions, determining the printing direction of different printing partitions according to classification; and performing integrated optimization of angle constraints; wherein, step S2 specifically comprises:
S2.1, determining the overhanging angle of the structural boundary: inputting the binary image obtained in step S1 in a matrix form to obtain density values in a neighborhood of each unit; if the density in the neighborhood of a unit is 0, the unit is a boundary unit; fitting the unit density of the boundary unit without binarization processing in the neighborhood to obtain a gradient normal vector of the boundary unit, and taking the orthogonal direction of the gradient normal vector as the boundary overhanging direction; and using a least square method to fit the unit density in the neighborhood to obtain the gradient direction of the unit density;
each unit supporting domain is divided by a six-unit mode or a nine-unit mode, each unit supporting domain is divided into a left supporting domain and a right supporting domain, normal vectors of a left boundary and a right boundary of the structure are obtained by fitting the unit density by the least square method, respectively, and the normal vectors of the left boundary and the right boundary are inner-producted with the structural molding direction, respectively, so as to obtain a magnitude of the left boundary and the right boundary of the structure violating a critical overhanging angle:
$$\{ \begin{matrix}{t}_{il} = ( cos {α}_{l} - cos \overline{α} ) ‖ ∇ {\tilde{ρ}}_{l} ‖ \leq {ε}_{i 1} \\ {t}_{ir} = ( cos {α}_{r} - cos \overline{α} ) ‖ ∇ {\tilde{ρ}}_{r} ‖ \leq {ε}_{i 1}\end{matrix} , i = 1 , 2 , … , nele$$
where cosαₗ and cosαᵣ are cosine values of the normal vectors of the left boundary and the right boundary of the structure, respectively; cos α̅ is a cosine of the critical overhanging angle of the structure; ∇\tilde{ρ} ₗ and ∇\tilde{ρ} ᵣ are gradient normal vectors of the left boundary and the right boundary of the structure, respectively; εᵢ₁ is the parameter approaching 0 and used to avoid numerical problems; tᵢₗ and tᵢᵣ are magnitudes of the left boundary and the right boundary violating the critical overhanging angle, respectively, tᵢₗ and tᵢᵣ are processed by a penalty function and converted into discrete values in the range of 0-1,
$$h ( x ) = \frac{1}{1 + {e}^{- μ x}}$$
where μ represents the smoothness of a function curve, μ has a value between 65 and 95, a parameter value A, characterizing the overhanging angle of the unit is as follows:
λᵢ=h(tᵢₗ−εᵢₗ)·h(tᵢᵣ−εᵢᵣ)
when the unit violates the critical overhanging angle of the structure, the value of A, is 1, otherwise the value is 0, that is:
$${λ}_{i} = \{ \begin{matrix}0 , {t}_{i l} - {ε}_{i 1} \leq 0 or {t}_{ir} - {ε}_{i 1} \leq 0 \\ 1 , others\end{matrix} ;$$
S2.2, determining the direction of the partition printing: extracting graphic feature points, dividing a grid using the feature points to discretize the design domain, obtaining different printing partitions, classifying the printing partitions according to the classification of the units contained in the printing partitions, and determining the printing directions of different partitions, respectively;
S2.3, integrated optimization of angle constraints: performing angle constraints on the units in each partition according to local printing directions of the structure determined in step S2.2 and realizing supplementary optimization design and printing of an insufficiently printed area;
S3, 3D printing integrated manufacturing: extracting structural information through optimization results, establishing a 3D solid model by a process of assembling components and generating nodes, partitioning and slicing the solid model, and generating a printing path for self-supporting multi-axis 3D printing manufacturing.

2. The method for optimizing design and manufacture of the self-supporting structure according to claim 1, wherein step S1 specifically comprises:
S1.1, structural topology optimization design: using the SIMP model based on density as a topology optimization method, using four-node rectangular units to discretize a design domain, and under a given load and given boundary conditions, using the density ρ=(ρ₁, ρ₂, . . . , ρₙₑₗₑ of each unit in the design domain as a design variable, wherein the equation of structural topology optimization is:
$$\{ \begin{matrix}find : ρ = ( {ρ}_{1} , {ρ}_{2} , … , {ρ}_{n e l e} ) \\ min : C ( ρ ) = {F}^{T} U = {U}^{T} K ( ρ ) U \\ s . t . : K ( ρ ) U = F \\ V ( ρ ) = \frac{{Σ}_{i = 1}^{n e l e} {v}_{i} {ρ}_{i}}{{Σ}_{i = 1}^{n e l e} {v}_{i}} \leq f \\ 0 \leq {ρ}_{i} \leq 1 , ( i = 1 , 2 , … , nele )\end{matrix}$$
where ρ=(ρ₁, ρ₂, . . . , ρₙₑₗₑ ) is a set of the density of each unit, and pᵢ is the density of the unit of the i-th unit in the set p; U is a global displacement vector; F is a global node load vector; K is a total stiffness matrix; an objective function C(ρ) is a total strain energy under an external force; v, is the volume of the i-th unit; f is the proportion of space; the unit density ρₑ has a value between 0 and 1;
the density ρₑ of all units in the structure obtained by topology optimization is subjected to density filtering and heaviside projection transformation to obtain \tilde{ρ} ₑ, and then the threshold δ=0.5 is set for \tilde{ρ} ₑ, and the equation of binarization processing of \tilde{ρ} ₑis as follows:
$${ρ}_{e}^{*} = \{ \begin{matrix}1 {\tilde{ρ}}_{e} \geq 0.5 \\ 0 {\tilde{ρ}}_{e} < 0.5\end{matrix}$$
S1.2, post-processing of topology optimization: post-processing isolated units and tiny holes in the obtained binary image by identifying a connected domain.

3. The method for optimizing design and manufacture of the self-supporting structure according to claim 1,wherein in step S2.1, a constraint term p(\tilde{ρ}) of the overhanging angle of the boundary unit and a constraint term q(\tilde{ρ}) of the unit density in the horizontal neighborhood of the unit are added to the equation of structural topology optimization, and the constraint item takes into account the parameter value γᵢ characterizing the overhanging feature of the structural boundary unit after topology optimization,
after taking into account the constraint item p(\tilde{ρ}) and the constraint item q(\tilde{ρ}), the optimization equation is:
$$\{ \begin{matrix}find : ρ = ( {ρ}_{1} , {ρ}_{2} , … , {ρ}_{n e l e} ) \\ min : C ( ρ ) = {F}^{T} U = {U}^{T} K ( \tilde{ρ} ) U \\ s . t . : K ( \tilde{ρ} ) U = F \\ V ( \tilde{ρ} ) = \frac{{Σ}_{i = 1}^{n e l e} {v}_{i} {\tilde{ρ}}_{e}}{{Σ}_{i = 1}^{n e l e} {v}_{i}} \leq f \\ 0 \leq {ρ}_{i} \leq 1 , ( i = 1 , 2 , … , nele ) \\ q ( \tilde{ρ} ) = \frac{{Σ}_{i = 1}^{n e l e} {γ}_{i} {v}_{i} {\tilde{ρ}}_{e}}{{Σ}_{i = 1}^{n e l e} {v}_{i}} \leq 0 \\ p ( \tilde{ρ} ) = \frac{{Σ}_{i = 1}^{n e l e} {λ}_{i} {v}_{i} {\tilde{ρ}}_{e}}{{Σ}_{i = 1}^{n e l e} {v}_{i}} \leq 0\end{matrix}$$
where U is a global displacement vector; F is a global node load vector; K is a total stiffness matrix; an objective function C(ρ) is a total strain energy under an external force; v, is a volume of the i-th unit; f is a proportion of space; q(\tilde{ρ}) is a constraint item of the unit density in the horizontal neighborhood of the unit, and p(\tilde{ρ}) is a constraint item of the overhanging angle of the boundary unit, where ρ=(ρ₁, ρ₂, . . . , ρₙₑₗₑ )is the set of the density of each unit, and \tilde{ρ}ᵢ is obtained from ρᵢ by density filtering and heaviside projection transformation; γᵢ, is the parameter value taking into account the overhanging feature of the boundary unit of the structure after topology optimization, y, is obtained with reference to the solution procedure for γᵢ.

4. The method for optimizing design and manufacture of the self-supporting structure according to claim 3, wherein in step S2.2, the printing partitions are classified into three categories, the printing partitions comprise Class I areas, Class II area and Class III area; Class I area only contains structure units, Class II area contains boundary units, and Class III area contains neither boundary units nor structure units; when judging the classification of the printing partitions in the part in the structure with vertical support, all units in the part with vertical support are not regarded as boundary units;
the local printing direction of Class I area is adjusted arbitrarily within the range of the overhanging angle; the local printing direction of Class II area is determined by the inclined direction of the boundary units; and the local printing direction of Class III area is set arbitrarily.

5. The method for optimizing design and manufacture of the self-supporting structure according to claim 4, wherein in step S2.2, an angle difference of the printing directions in the horizontally adjacent areas is greater than a maximum deflection angle; and a local optimal printing direction of different printing partitions is determined by the following equation:
$$\{ \begin{matrix}find : φ = ( {φ}_{1} , {φ}_{2} , … , {φ}_{n} ) \\ min : {o}^{T} V \\ s . t . : o \geq \vert M φ - \overline{φ} - {φ}_{max} \vert + \vert M φ - \overline{φ} + {φ}_{max} \vert \\ {φ}_{n e x t} - {φ}_{f i τ s t} > {φ}_{t , max}\end{matrix}$$
Where M is a mapping matrix consisting of 0-1 , which is used to obtain the print partition corresponding to each unit; and φ=(φ₁, φ₂, . . . , φₙ) is the local printing direction of each printing partition, o represents that the inclination angle of the unit violates the critical overhanging constraints; φ̅ is the inclination angle of the unit; φₘₐₓ is the maximum overhanging angle; φₙₑₓₜ and φ_{first} are the angles of the local printing direction of two adjacent printing partitions, respectively, and φ_{t,max} is the maximum deflection angle.

6. The method for optimizing design and manufacture of the self-supporting structure according to claim 5, wherein in step S2.3, the optimal local printing direction of each partition is determined by the inclined direction of the boundary units in each partition, and the local printing direction of the structure is used in the constraint item p(γᵢ) to characterize the parameter value λᵢ(φᵢ) of the overhanging angle of the unit, and the equation taking into account the linear angle constraint of the unit in each printing partition is:
$$\{ \begin{matrix}find : ρ = ( {ρ}_{1} , {ρ}_{2} , … , {ρ}_{n e l e} ) \\ min : C ( ρ ) = {F}^{T} U = {U}^{T} K ( \tilde{ρ} ) U \\ s . t . : K ( \tilde{ρ} ) U = F \\ V ( \tilde{ρ} ) = \frac{{Σ}_{i = 1}^{n e l e} {v}_{i} {\tilde{ρ}}_{e}}{{Σ}_{i = 1}^{n e l e} {v}_{i}} \leq f \\ 0 \leq {ρ}_{i} \leq 1 , ( i = 1 , 2 , … , nele ) \\ q ( \tilde{ρ} ) = \frac{{Σ}_{i = 1}^{n e l e} {γ}_{i} {v}_{i} {\tilde{ρ}}_{e}}{{Σ}_{i = 1}^{n e l e} {v}_{i}} \leq 0 \\ p ( \tilde{ρ} ) = \frac{{Σ}_{i = 1}^{n e l e} {λ}_{i} ( {φ}_{i} ) {v}_{i} {\tilde{ρ}}_{e}}{{Σ}_{i = 1}^{n e l e} {v}_{i}} \leq 0\end{matrix}$$
where U is a global displacement vector; F is a global node load vector; K is a total stiffness matrix; an objective function C(ρ) is a total strain energy under an external force; v, is a volume of the i-th unit; f is a proportion of space; q(\tilde{ρ}) is a constraint term of the unit density in the horizontal neighborhood of the unit, and p(\tilde{ρ}) is a constraint item of the linear angle of the optimal local printing direction of the unit in each partition, where ρ=(ρ₁, ρ₂, . . . , ρₙₑₗₑ ) is the set of the density of each unit; \tilde{ρ}ᵢ is obtained from p, by density filtering and heaviside projection transformation, and λᵢ(φᵢ) is a parameter characterizing the optimal local printing direction of the unit.

7. The method for optimizing design and manufacture of the self-supporting structure according to claim 1, wherein in step S3, 3D modeling is performed by Rhino software; a solid model obtained by 3D modeling is sliced by Cura software, and the printing path is generated.
